(19) United States
(12) Patent Application Publication
(10) Pub. No.: US 2006/0003834 A1
(43) Pub. Date: Jan. 5, 2006

(54) Gaming machine

(76) Inventor: Wataru Okada, Tokyo (JP)

Correspondence Address: ARENT FOX PLLC, 1050 CONNECTICUT AVENUE, N.W., SUITE 400, WASHINGTON, DC, 20036, US

(21) Appl. No.: 11/139,039

(22) Filed: May 27, 2005

(30) Foreign Application Priority Data
Jun. 30, 2004 (JP) 2004-192994

(51) Int. Cl. A63F 13/00

(52) U.S. Cl. 463/25; 463/20

(57) ABSTRACT

A gaming machine comprising: winning managing means for managing winning probability for each winning arrangement based on an amount of gaming values inputted by a player; winning determining means for determining the winning arrangement based on a winning probability and a random number by a lottery for each unit game; payout number managing means for managing an amount of gaming values paid out to said player in association with said winning arrangement and the amount of inserted gaming values; and gaming state shift means for shifting a gaming state between a general gaming state and a special gaming state which is in higher probability.

### CROSS-REFERENCE TO RELATED APPLICATIONS

This application is based upon and claims the benefits of priority from Japanese Patent Application No. 2004-192994 filed on Jun. 30, 2004, the entire contents of which are incorporated herein by reference.

1. Field of the Invention

The present invention relates to a gaming machine.

2. Related Art

For example, a slot machine with a stop button, what is called pachi-slot machine, has a variable display device including multiple arrays of mechanically rotational reels which displays multiple symbols within a front display window or an electric variable display device which displays symbols to be shown on the reels on a screen. In response to a start operation by a player, a control unit drives the variable display device and thus rotates the reels so that the symbols to be shown can be varied. Then, automatically after a predetermined period of time or in response to a stop operation by the player, the control unit sequentially stops the rotations of the reels. In this case, a profit can be given to the player by paying out a gaming medium such as a coin and a medal when a specific combination (winning symbol arrangement) of symbols is completed on the reels appearing within the display window.

A machine of a current mainstream is the one having multiple kinds of winning arrangements. In particular, when a predetermined winning arrangement is won, a gaming state is kept under a better condition than a normal condition for a predetermined period of time as well as one coin payout to be executed. Such a winning arrangement may be a winning arrangement (to be referred to as “RB” (that is, regular bonus) hereinafter) allowing a predetermined number of games under the better condition to be played such that the player may obtain relatively larger profit.

With the machine of the current mainstream type, in order to achieve a predetermined symbol combination along an activated pay line (to be referred to as “activated line,” hereinafter) so as to obtain an winning arrangement resulting in payout of a coin or a medal, it is required to win the winning arrangement (to be referred to as “internal win” hereinafter) in an internal lottery processing (to be referred to as “internal lottery” hereinafter) and to perform a stop operation in good timing so as to stop a combination of symbols in the activated line, which match the winning arrangement having been won internally (to be referred to as “internal winning arrangement” hereinafter). In other words, even when any internal winning arrangements are won, the winning cannot be achieved if the player performs the stop operation in wrong timing. That is, the gaming machine of current mainstream type requires the technique to perform the stop operation in good timing (to be referred to as “observation push”, which characterizes the machine as technique-oriented one) (see JP-B-3-72313, for example). “Unexpected loss” occurs when the player fails in “observation push” and cannot win any winning arrangement. The gaming machine of the current mainstream type is configured to carry over information of a fact that an RB has been internally won when the player unexpectedly loses the RB even though the RB has been internally won in the game.

However, a more amusing gaming machine than the above gaming machine is desired from a different point of view.

### SUMMARY OF THE INVENTION

Accordingly, it is an object of the present invention to provide an amusing gaming machine.

There is provided a gaming machine by which a unit game (such as one game) is performed under a condition that a gaming value (e.g., coin, medal, credit number, etc.) is inserted by a player, the gaming machine including winning probability managing means (such as each probability lottery table shown in FIG. 4, which will be described later, a ROM 32 that stores the probability lottery table and a main control circuit 71 that refers to the probability lottery table) that manages a winning probability for each winning arrangement in accordance with a number of gaming values or media (e.g., coin, medal, credit number, etc.) inserted by the player, winning arrangement determining means (such as the main control circuit 71 that performs probability lottery processing in step S12 in FIG. 11B, which will be described later) that determines an winning arrangement based on a random number by a lottery and the winning probability managed by the winning probability managing means for each unit game, payout number managing means (such as a table that stores information relating to a number-of-medals-to-pay shown in FIG. 3, which will be described later, the ROM 32 (see FIG. 10) that stores the probability lottery table and the main control circuit 71 that refers to the table) that manages the number of gaming values or media to be paid out to the player, and gaming state shifting means (such as gaming stage monitoring processing in step S11 in FIG. 11B, which will be described later, and the main control circuit 71 that performs processing in step S38 in FIG. 13) that shifts the gaming stage between a normal gaming state (such as a general gaming state, which will be described later) in which a predetermined combination (such as REPLAY, which will be described later) is determined as a winning arrangement based on a first winning probability managed by the winning probability managing means and a special gaming state (such as a high probability replay stage (non-carry-over or carry-over) in which the predetermined combination is determined as a winning arrangement based on a second winning probability which is a higher probability than the first winning probability and is managed by the winning probability managing means.

Since, according to the present invention, the gaming machine includes the winning probability managing means that manages a winning probability for each winning arrangement in accordance with a gaming value inserted by a player, various winning probabilities in accordance with gaming values inserted by a player can be defined, which may improve the amusement of the gaming machine.

Since the gaming machine includes the payout number managing means that manages the number of gaming value inserted by a player and the number of gaming value to be paid out to the player in accordance with a winning arrangement determined by the winning arrangement determining means, a variety of gaming values or media being paid out to the player may be provided in accordance with a gaming value or media inserted by the player. Thus, the amusement of the gaming machine may be improved.

Since the gaming machine includes the gaming state shifting means that shifts the gaming stage between a general gaming state in which a predetermined combination is determined as a winning arrangement based on a first winning probability managed by the winning probability managing means and a special gaming state in which the predetermined combination is determined as a winning arrangement based on a second winning probability which is a higher probability than the first winning probability and is managed by the winning probability managing means, different probabilities can be provided for winning a predetermined winning arrangement, which may improve the amusement of the gaming machine.

According to the invention, inventive amusement can be provided, and the amusement of a game can be increased.

Further features of the present invention, its nature, and various advantages will be more apparent from the accompanying drawings and the following description of the preferred embodiment.

### BRIEF DESCRIPTION OF THE DRAWINGS

FIG. 1 is a perspective view of a gaming machine according to an embodiment.

FIG. 2 is a diagram showing symbol examples aligned on reels.

FIG. 3 is a diagram showing relationships among winning arrangements, symbol combinations and payout numbers.

FIGS. 4A to 4E are diagrams showing probability lottery table examples.

FIGS. 5A and 5B are diagrams showing relationships among internal winning arrangements, payout numbers, winning probabilities and expected payout numbers in accordance with numbers of BETs.

FIG. 6 is a diagram showing a stop winning arrangement select table.

FIG. 7 is a diagram showing a stop table group determination table.

FIGS. 8A and 8B are diagrams showing stop table examples.

FIGS. 9A and 9B are diagrams showing stop table examples.

FIG. 10 is a block diagram showing a configuration of an electric circuit according to an embodiment.

FIGS. 11A and 11B show a main flowchart for an operation of a main control circuit 71.

FIG. 12 is a flowchart subsequent to FIGS. 11A and 11B.

FIG. 13 is a flowchart subsequent to FIG. 12.

### DETAILED DESCRIPTION OF THE PREFERRED EMBODIMENT

A pachi-slot machine, which is an example of a gaming machine according to the present invention, will be described below in detail with reference to drawings. However, the present invention is not limited to the embodiment, and various modifications and changes in design can be made without departing from the scope of the present invention.

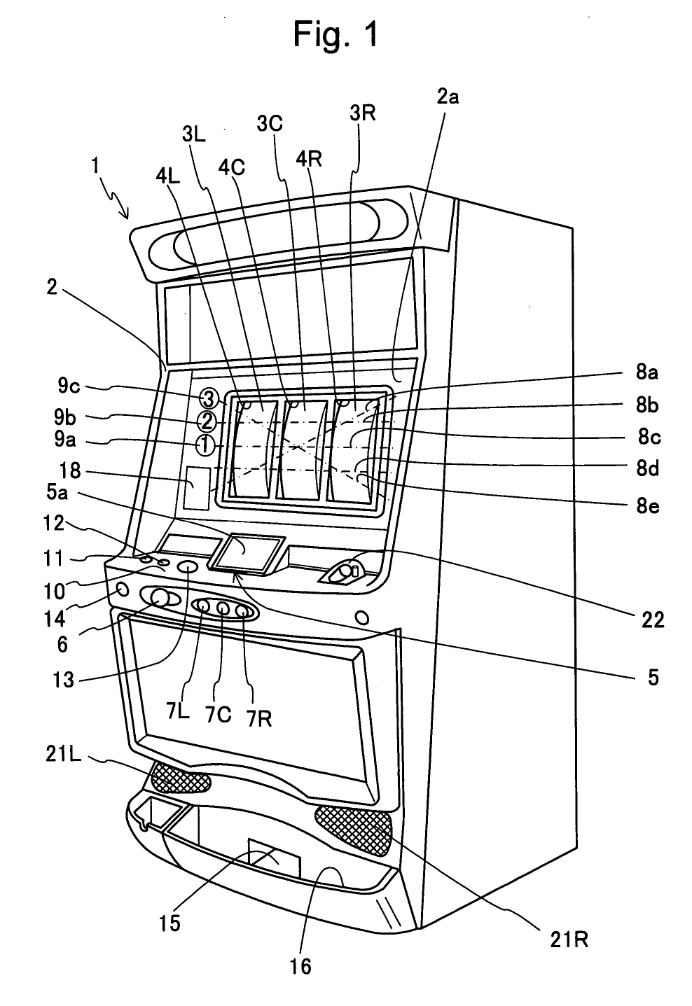

FIG. 1 is a perspective view showing an appearance of a gaming machine 1 according to an embodiment of the invention. The gaming machine 1 is a so-called “pachi-slot machine”. The gaming machine 1 may be played with a coin, a medal, a gaming ball or a token or a gaming medium such as a card storing information on a gaming value having been given to or to be given to a player. The gaming machine 1 in the following description is played with a medal, by way of example.

The gaming machine 1 has a panel display unit 2a having a substantially vertical plane, on the front of a cabinet 2 forming the whole of the gaming machine 1 and has vertically-oriented rectangular display windows 4L, 4C and 4R at the center. As pay lines, the display windows 4L, 4C and 4R horizontally have a top line 8b, a center line 8c and bottom line 8d and diagonally have a cross-up line 8a and a cross-down line 8e. One, three or five of these pay lines are activated in response to a manipulation on a single bet switch 11, double bet switch 12 and maximum BET switch 13, which will be described later, or in response to an insertion of a medal to a medal insertion slot 22. The activated pay line is indicated by lighting on BET lamps 9a, 9b and/or 9c, which will be described later.

In this case, the pay lines 8a to 8e relate to the success or failure in winning a winning arrangement. More specifically, a predetermined winning arrangement is won when a set including one kind of symbol corresponding to a predetermined winning arrangement (such as “sub winning arrangement of Bell”, which will be described later), that is, one kind of symbol included in a symbol combination corresponding to a predetermined winning arrangement is stopped at a predetermined position corresponding to any one of the activated lines.

Three reels 3L, 3C and 3R are rotatably and horizontally provided within the cabinet 2. Each of the three reels 3L, 3C and 3R has a symbol column including multiple kinds of symbol on the outer periphery and functions as a variable display unit. The symbols on the reels can be observed through the display windows 4L, 4C and 4R. Each of the reels rotates at a constant speed (such as 80 rpm).

A single bet lamp 9a, a double bet lamp 9b, a maximum BET lamp 9c and an information display unit 18 are provided on the left of the display windows 4L, 4C and 4R. The single bet lamp 9a, double bet lamp 9b and maximum BET lamp 9c light in accordance with the number of medals (which will be called “number of BETs” hereinafter) bet on one game.

The single bet lamp 9a lights when the number of BETs is “1” and one pay line is activated (that is, when one activated line is defined). The double bet lamp 9b lights when the number of BETs is “2” and three pay lines are activated (that is, when three activated lines are defined). The maximum BET lamp 9c lights when the number of BETs is “3” and all (that is, five) pay lines are activated (that is, when all (that is, five) activated lines are defined). The information display unit 18 includes a 7-segmented LED and may display a number of stored (credited) medals and a number of medals to be paid out upon winning.

A horizontal base unit 10 is provided below the display windows 4L, 4C and 4R. An LCD device 5 is provided between the base unit 10 and the display windows 4L, 4C and 4R. A display screen 5a of the LCD device 5 displays information relating to a game, such as information on a fact that Regular Bonus, which will be described later, has been internally won. The medal insertion slot 22 is provided on the right of the LCD device 5, and the single bet switch 11, double bet switch 12 and maximum BET switch 13 are provided on the left of the LCD device 5.

The single bet switch 11 may be pressed once to bet one of credited medals on a game. The double bet switch 12 may be pressed once to bet two of credited medals on the game. The maximum BET switch 13 may be pressed once to bet a maximum number of medals on one game. The BET switches 11, 12 and 13 may be manipulated to activate a predetermined pay line as described above. The number of BETs refers to the number of medals bet on one game by the player.

A C/P switch 14 is provided on the left of the front face of the base unit 10. The C/P switch 14 may be pressed to switch credit or payout of medals obtained by a player during a game. Upon switching on the C/P switch 14, a medal is paid out from a medal payout opening 15 at the lower part of the front, and the paid medal is stored in a medal tray 16. A start lever 6 is mounted rotationally in a predetermined angle range on the right of the C/P switch 14. The start lever 6 may be used to rotate the reels in response to a manipulation by a player and start the variable display of symbols within the display windows 4L, 4C and 4R.

Three stop buttons (stop operation unit) 7L, 7C and 7R are provided at the center of the front face of the base unit 10 and at a lower position of the LCD device 5. The stop buttons 7L, 7C and 7R may be used to stop rotations of the three respective reels 3L, 3C and 3R. Speakers 21L and 21R are provided on the upper left and right of the medal tray 16. Basically, according to this embodiment, one game (unit game) starts in response to a manipulation on the start lever 6 and ends when all of the reels 3L, 3C and 3R stop.

Here, according to this embodiment, the maximum number of sliding frames is defined at “4” in all gaming states. The expression, “the number of sliding frames” basically refers to the number of symbols displayed during a period from a manipulation on each of the stop buttons 7L, 7C and 7R (or from detection of the manipulation) to the stop of corresponding each of the reels 3L, 3C and 3R. Furthermore, the expression, “the number of sliding frames” refers to the number of symbols (amount of movement of a symbol) moved after each of the stop buttons 7L, 7C and 7R is manipulated until the respective each of the reels 3L, 3C and 3R stops. More specifically, the number of sliding frames refers to the number of symbols the center of which have crossed a predetermined pay line such as the center line 8c after each of the stop buttons 7L, 7C and 7R is manipulated until respective each of the reels 3L, 3C and 3R stops.

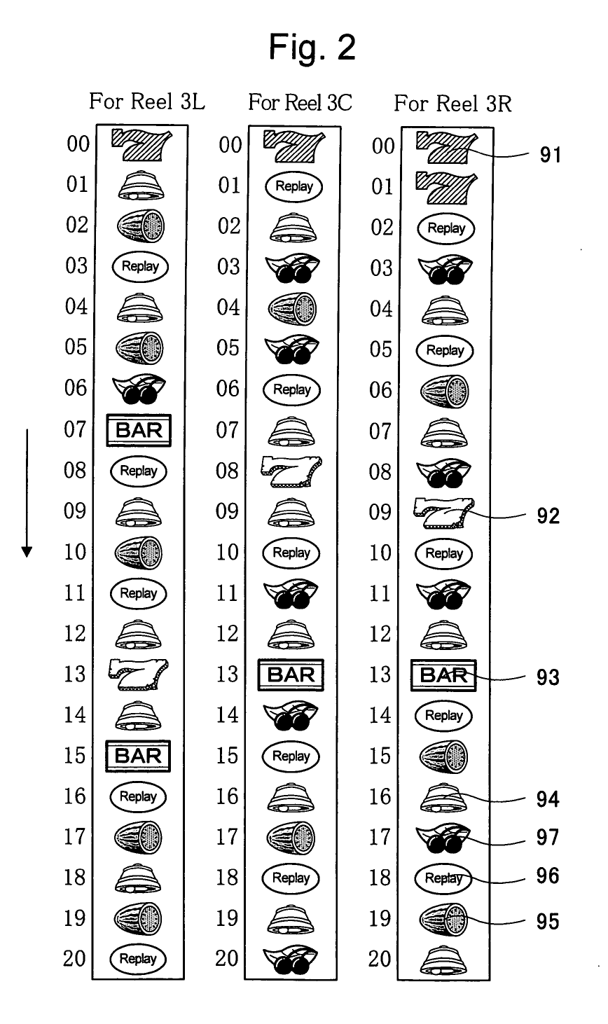

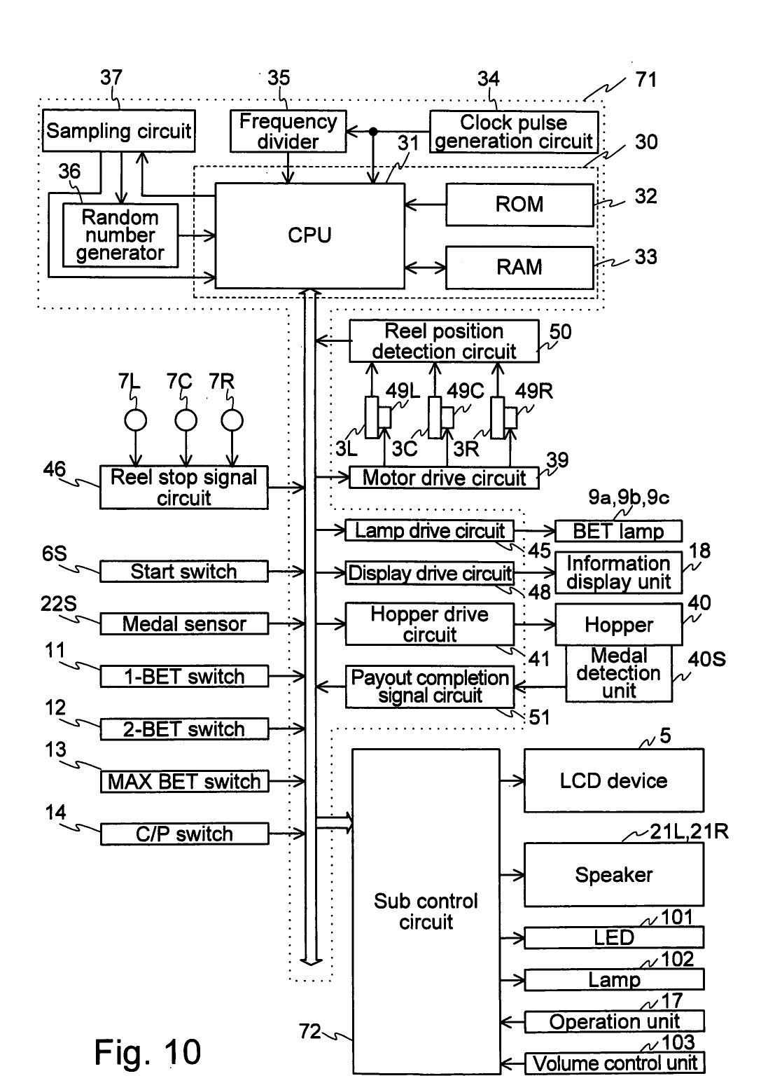

FIG. 2 shows symbol columns in which the reels 3L, 3C and 3R have twenty one symbols of multiple kinds. Code numbers 00 to 20 are given to symbols and are stored (saved) in the ROM 32 (FIG. 10), which will be described later as a data table. Each of the reels 3L, 3C and 3R has a symbol column including “Red7 (Symbol 91)”, “Blue7 (Symbol 92)”, “BAR (Symbol 93)”, “Bell (Symbol 94)”, “Watermelon (Symbol 95)”, “Replay (Symbol 96)” and “Cherry (Symbol 97)”. Each of the reels 3L, 3C and 3R is rotationally driven to move in the direction indicated by the arrow in FIG. 2.

Here, winning arrangements of this embodiment include RB, Replay and sub winning arrangements of Bell, but the symbols, “Watermelon (Symbol 95)” and “Cherry (Symbol 97)”, shown in FIG. 2 do not relate to completion of a winning arrangement. Notably, RB is a first kind special won game.

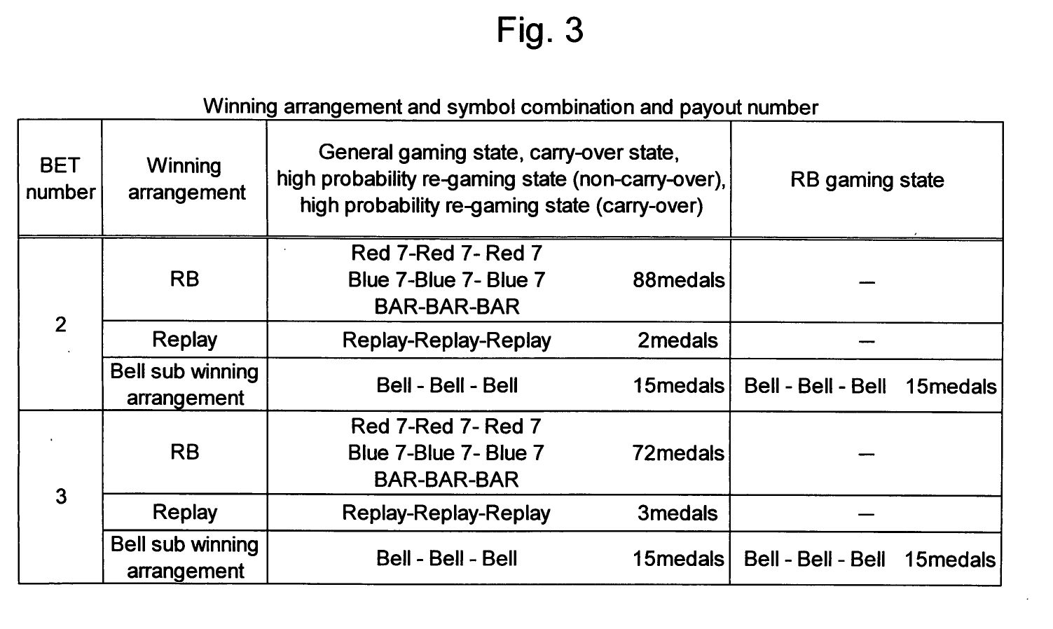

Winning arrangements, combinations of symbols and numbers of medals to pay out will be described with reference to FIG. 3.

The gaming machine 1 can enter into five gaming states of a general (or normal) gaming state, a carry-over state, a high probability re-gaming state (non-carry-over), a high probability re-gaming state (carry-over) and an RB gaming state.

Winning of the RB is achieved by a completion of “Red7-Red7-Red7”, “Blue7-Blue7-Blue7” or “BAR-BAR-BAR” on an activated line. When the RB is won, the gaming state is shifted to the RB gaming state. The RB gaming state ends when a sub winning arrangement of Bell is won eight times in the RB gaming state and is shifted to the high probability re-gaming state (non-carry-over). The high probability re-gaming state (non-carry-over) ends when a sub winning arrangement of Bell is internally won. Though eighty eight (88) medals and seventy two (72) medals are given in FIG. 3 when the RB is won with two and three medals bet, respectively, in the general gaming state and high probability re-gaming state (non-carry-over), the number of medals in FIG. 3 is the average total (expected) number of medals to be paid out to the player for winning of the sub winning arrangement of Bell during the shifted RB gaming state. Notably, when the RB is won, the number of medals to be paid out is zero (0).

A win of Replay is achieved by completion of “Replay-Replay-Replay” on an activated line. When Replay is won, the equal number of medals to the number of inserted medals are automatically inserted. Thus, the player can play the next game without consuming any medals. In other words, Replay is a winning combination by which the equal number of medals to the number of inserted medals are given to the player and by which another game can be played without inserting any gaming value (i.e., medals). When the Replay is won in the general gaming state or high probability re-gaming state (non-carry-over or carry-over), two medals are automatically inserted and given to the player with 2 medals bet. Three medals are automatically inserted and given to the player with 3 medals bet.

Winning of a sub winning arrangement of Bell is achieved by completion of “Bell-Bell-Bell” on an activated line. Irrespective of the gaming state and the number of BETs, 15 medals are given to a player when the sub winning combination of Bell is won.

The sub winning arrangement of Bell, the Replay and the RB may be won in the general gaming state and the high probability re-gaming state (non-carry-over). The sub winning arrangement of Bell and the Replay may also be won in the high probability re-gaming state (carry-over). The sub winning combination of Bell may be only won in the RB gaming state. Winning of no winning arrangements results in Loss, and no medals are to be given or paid to the player.

Though, according to this embodiment, the requirement for the shift to the high probability re-gaming state (non-carry-over) (that is, the requirement for the occurrence of the high probability re-gaming state (non-carry-over)) is:
(1): the end of the RB gaming state. However, the present invention is not limited thereto. The requirements for the shift may be as follows.
(2): That the RB is internally won, or the winning flag of the RB is carried over to the next game since the player unexpectedly has lost the RB in the game in which the RB has been internally won.
(3): That the RB is won.
(4): That a combination of specific kinds of symbols is stopped when the RB has not been internally won or the gaming state is not the RB gaming state.
(5): That a predetermined gaming result is obtained a predetermined number of times after the requirement (3) or (4) is satisfied.
(6): A requirement combining any or all of the requirements (1) to (5).

Though, according to this embodiment, the requirement for the shift from the high probability re-gaming state (non-carry-over or carry-over) (that is, the requirement for the end of the high probability re-gaming state (non-carry-over or carry-over)) is:
(1′): that the sub winning combination of Bell has been internally won as described above. However, the present invention is not limited thereto. The requirements for the shift may be as follows.
(2′): That the RB has been internally won.
(3′): That a predetermined number of games (such as 100 games) have been finished after a predetermined winning arrangement (such as the RB and the sub winning combination of Bell) is internally won.
(4′): That a predetermined number of games have been finished where the predetermined number of games to finish is determined by a lottery under a precondition of (3′).
(5′): That the shift to the general gaming state is caused by the result from the determination on whether the gaming state is to be shifted to the general gaming state or not by a lottery when a predetermined winning arrangement (such as the RB and the sub winning arrangement of Bell) is internally won.
(6′): That the shift to the general gaming state is caused by a result from the determination by a lottery whether the gaming state is to be shifted to the general gaming state or not during either a period of time easily allowing the shift to the general gaming state or a period of time not easily allowing the shift to the general gaming state by assuming of (5′).
(7′): A requirement combining any or all of the requirements (1′) to (6′).

The gaming state is shifted to the general gaming state when a sub winning arrangement of Bell is internally won in a game in the high probability re-gaming state (non-carry-over).

The carry-over state is a gaming state in which information that the RB has been internally won is saved and is carried over to games following the game when the RB has been internally won but has been unexpectedly lost by the player in the game in the general gaming state. Alternatively, the shift to the carry-over state is implemented when a sub winning combination of Bell is internally won in a game in the high probability re-gaming state (carry-over).

The high probability re-gaming state (carry-over) is a gaming state in which information that the RB has been internally won is saved and is carried over to games following the game when the RB has been internally won but has been unexpectedly lost by the player in the game in the high probability re-gaming state (non-carry-over).

The high probability re-gaming state (non-carry-over) is a gaming state followed by the end of the RB gaming state.

The RB gaming state is a gaming state followed by winning of the RB in any one of the general gaming state, carry-over state and high probability re-gaming state (carry-over).

Notably, one piece of information that the RB has been internally won may be carried over in the carry-over state and high probability re-gaming state (carry-over). In other words, one win of RB may be carried over.

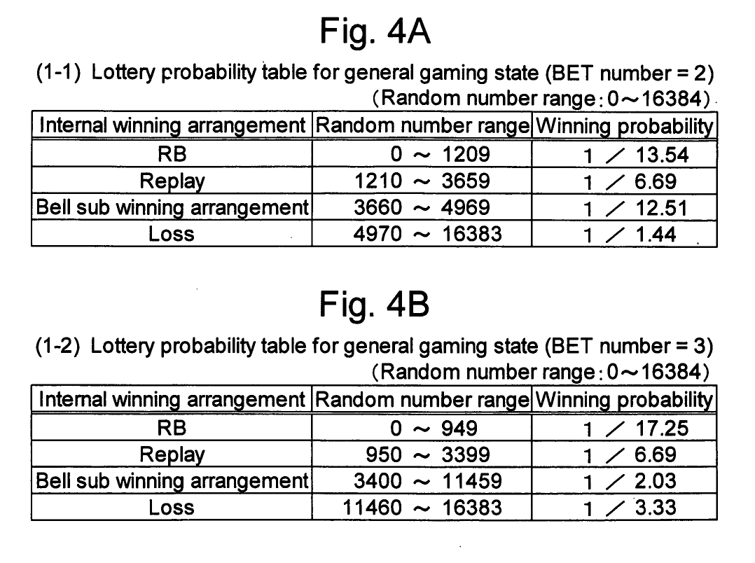

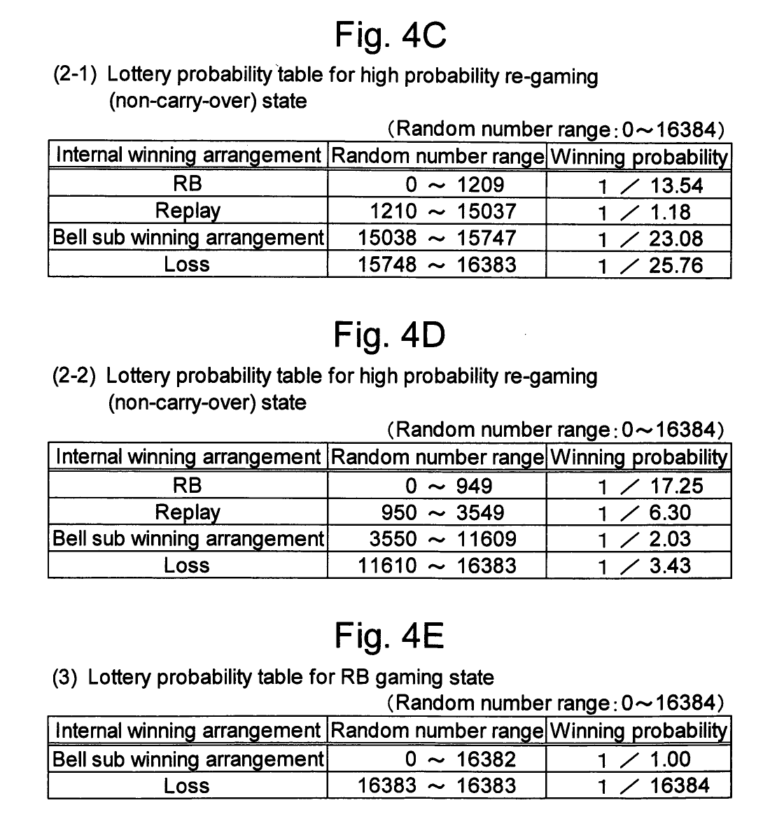

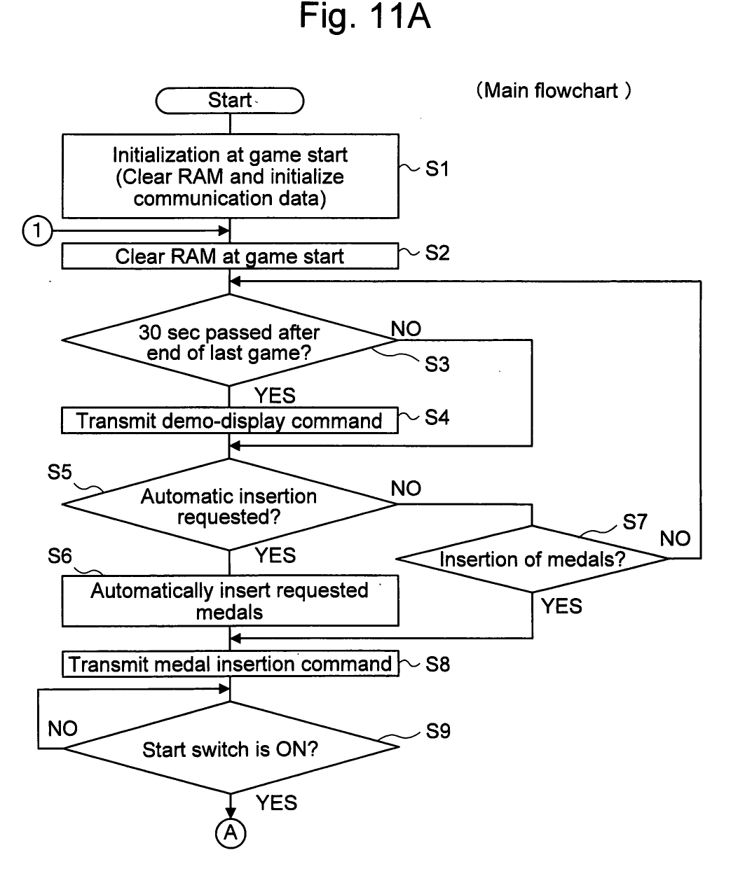

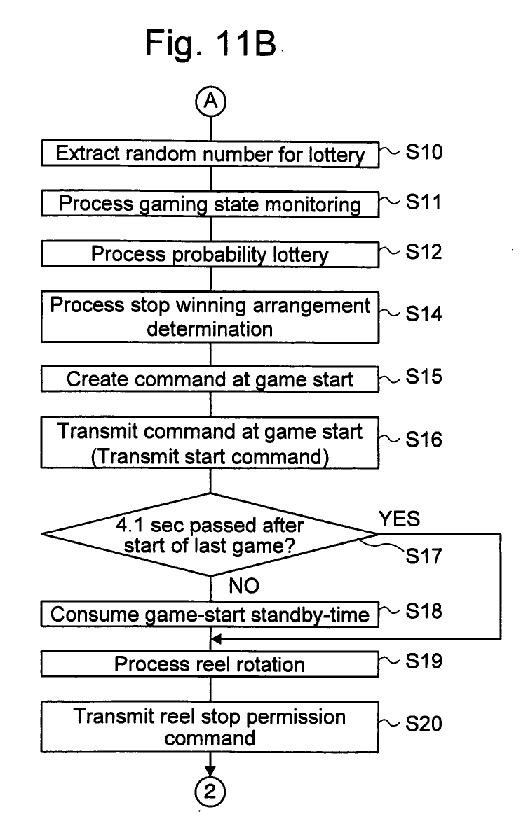

Next, probability lottery tables for managing winning probabilities at which internal winning arrangements are won for the gaming states and numbers of BETs will be described with reference to FIGS. 4A to 4E. Notably, the range of random number extraction (or drawing) of the probability lottery tables is 0 to 16383. These tables are stored in the ROM 32 (see FIG. 10), which will be described later, and are referred to in the probability lottery processing in step S12 in FIG. 11B, which will be described later.

FIG. 4A is a general gaming state probability lottery (with 2 medals bet) table. This table is referred to in a probability lottery where 2 medals are bet (which is a predetermined number of inserted medals) in the general gaming state. The winning probabilities of the internal winning arrangements of the RB, the Replay, the sub winning arrangement of Bell and the Loss are 1/13.54, 1/6.69, 1/12.51 and 1/1.44 based on the table.

FIG. 4B is a general gaming state probability lottery (with 3 medals bet) table. This table is referred to in a probability lottery where 3 medals are bet (which is a specific number of inserted medals) in the general gaming state. The winning probabilities of the internal winning arrangements of the RB, the Replay, the sub winning arrangement of Bell and the Loss are 1/17.25, 1/6.69, 1/2.03 and 1/3.33 based on the table.

FIG. 4C is a high probability re-gaming state (non-carry-over) probability lottery (with 2 medals bet) table. This table is referred to in a probability lottery where 2 medals are bet (which is a predetermined number of inserted medals) in the high probability re-gaming state. The winning probabilities of the internal winning arrangements of the RB, the Replay, the sub winning arrangement of Bell and the Loss are 1/13.54, 1/1.18, 1/23.08 and 1/25.76 based on the table.

FIG. 4D is a high probability re-gaming state (non-carry-over) probability lottery (with 3 medals bet) table. This table is referred to in a probability lottery where 3 medals are bet (which is a specific number of inserted medals) in the high probability re-gaming state. The winning probabilities of the internal winning arrangements of the RB, the Replay, the sub winning arrangement of Bell and the Loss are 1/17.25, 1/6.30, 1/2.03 and 1/3.43 based on the table.

The predetermined number of inserted medals is not limited to the case where 2 medals are bet, but is applicable to a case with 1 or 3 or a plural number. The specific number of inserted medals is not limited to the case where 3 medals are bet, but is applicable to a case with 1 or 2 or a plural number. However, the predetermined number of inserted medals and the specific number of inserted medals may be set in a different manner from each other.

FIG. 4E shows an RB gaming state probability lottery table. This table is referred to in a probability lottery in the RB gaming state irrespective of the number of BETs. The winning probabilities of the internal winning arrangements of the sub winning arrangement of Bell and the Loss are 1/1.00 and 1/16384 based on the table.

The high probability lottery tables for the general gaming state and the high probability re-gaming state (non-carry-over) are applicable to a case with 1 medal bet, but according to this embodiment, the description will be omitted herein. The probability lottery tables for the carry-over state and the high probability re-gaming state (carry-over) are also applicable to cases with 1, 2 and 3 of medal bets. However, the detail description will be omitted herein though the probability lottery tables are characterized by being configured to prevent winning of a bonus (such as the RB) also by being referred to in a probability lottery.

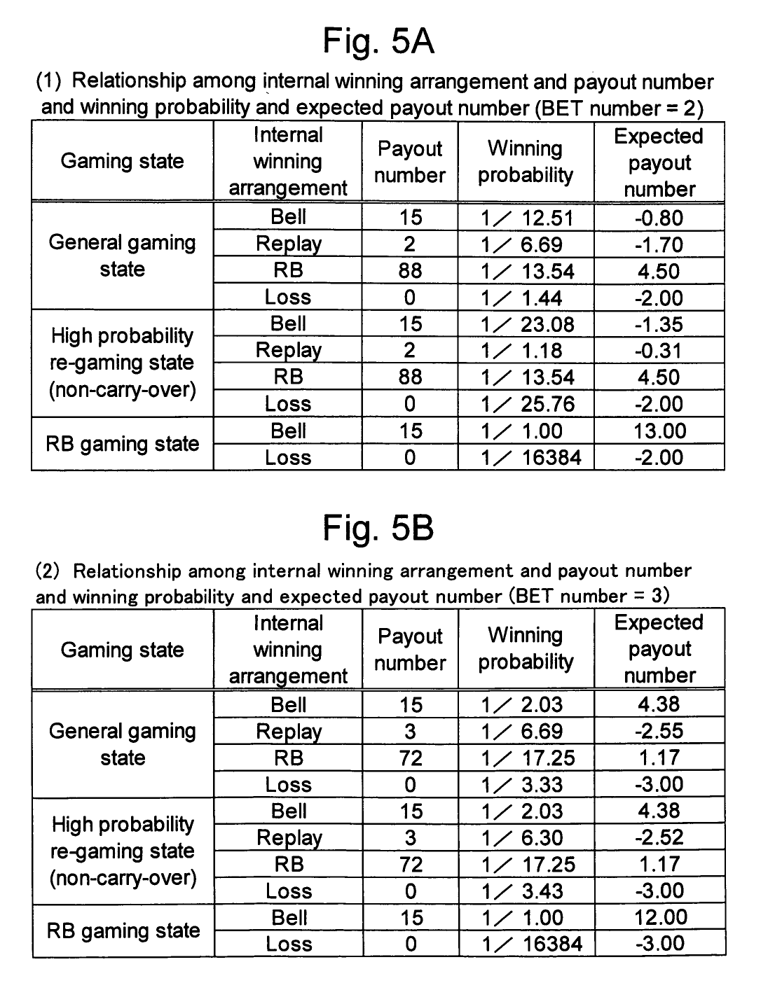

Next, characteristics of amusement of the gaming machine 1 according to the present invention will be described with reference to FIGS. 5A and 5B and based on the expected numbers of medals obtained by a player (that is, average values of the numbers of medals obtained by the player) in one game with reference to one of the probability lottery tables in FIGS. 4A to 4E.

FIG. 5A describes the numbers of paid medals, winning probabilities and expected payout numbers of medals in one game for the gaming states and internal winning arrangements when two (2) medals are bet. Here, the expected payout number of medals is the number resulting from the subtraction of two medals having been bet from the multiplication of the number of medals to be paid out to the player based on the internal winning arrangement by the winning probability of the internal winning arrangement. In other words, the expected payout number of medals refers to the number of expected medals that the player can obtain in one game. The payout number may include a fractional number. Especially, it is useful to use the fractional number for the statistical analysis.

In FIG. 5A, the expected number of obtained medals is:
15×(1/12.51)−2=−0.80
where the internal winning arrangement is the sub arrangement of Bell in the general gaming state. Similarly, the expected numbers of obtained medals for the other internal winning arrangements, that is, the Replay, the RB and the Loss are −1.70, 4.50 and −2.00, respectively as a result of multiplication of the respective numbers of medals to pay by a winning probability and subtraction of 2 therefrom. Here, the sum of the expected number of obtained medals for these internal winning arrangements is:
−0.80−1.70+4.50−2.00=0.
In other words, the expected number of medals that the player can obtain in one game in the general gaming state converges to zero in a long term when two (2) medals are bet.

In FIG. 5A, the expected number of obtained medals is:
15×(1/23.08)−2=−1.35
where the internal winning arrangement is the sub arrangement of Bell in the high probability re-gaming state (non-carry-over). Similarly, the expected payout numbers of medals for the other internal winning arrangements, that is, the Replay, the RB and the Loss are −0.31, 4.50 and −2.00, respectively, as a result of multiplication of the respective numbers of medals to be paid by a winning probability and subtraction of 2 therefrom. Here, the sum of the expected payout number of medals for these internal winning arrangements is:
−1.35−0.31+4.50−2.00=0.84.
In other words, the expected number of medals that the player can obtain in one game in the high probability re-gaming state (non-carry-over) converges to 0.84 in a long term when two (2) medals are bet.

In FIG. 5A, the expected number of obtained medals is:
15×(1/1.00)−2=13.00
where the internal winning arrangement is the sub arrangement of Bell in the RB gaming state. The expected number of obtained medals for the Loss is −2.00. Here, the sum of the expected payout number of medals for these internal winning arrangements is:
13.00−2.00=11.00.
In other words, the expected payout number of medals that the player can obtain in one game in the RB gaming state converges to 11.00 in a long term when two (2) medals are bet.

The number of medals to be paid for an internal winning arrangement of the RB is equal to 88 which is a result from the multiplication of an expected payout number of medals of 11.00 in one game in the RB gaming state by eight, which is the number of times that the sub winning arrangement of Bell may be internally won in one RB gaming state, when two (2) medals are bet since one RB gaming state ends with eight internal wins of the sub winning arrangement of Bell.

FIG. 5B describes the numbers of paid medals, winning probabilities and expected payout numbers of medals in one game for the gaming states and internal winning arrangements when three (3) medals are bet.

In FIG. 5B, the expected payout number of medals is:
15×(1/2.03)−3=4.38
where the internal winning arrangement is the sub arrangement of Bell in the general gaming state. Similarly, the expected payout numbers of medals for the other internal winning arrangements, that is, the Replay, the RB and the Loss are −2.55, 1.17 and −3.00, respectively, as a result of multiplication of the respective numbers of medals to be paid by a winning probability and subtraction of 3 therefrom. Here, the sum of the expected payout number of medals for these internal winning arrangements is:
4.38−2.55+1.17−3.00=0.
In other words, the expected payout number of medals that the player can obtain in one game in the general gaming state converges to zero in a long term when three (3) medals are bet.

In FIG. 5B, the expected number of obtained medals is:
15×(1/2.03)−3=4.38
where the internal winning arrangement is the sub arrangement of Bell in the high probability re-gaming state (non-carry-over). Similarly, the expected payout numbers of medals for the other internal winning arrangements, that is, the Replay, the RB and the Loss are −2.52, 1.17 and −3.00, respectively, as a result of multiplication of the respective numbers of medals to be paid by a winning probability and subtraction of 3 therefrom. Here, the sum of the expected payout number of medals for these internal winning arrangements is:
4.38−2.52+1.17−3.00=0.03.
In other words, the expected payout number of medals that the player can obtain in one game in the high probability re-gaming state (non-carry-over) converges to 0.03 in a long term when three (3) medals are bet.

In FIG. 5B, the expected payout number of medals is:
15×(1/1.00)−3=12.00
where the internal winning arrangement is the sub arrangement of Bell in the RB gaming state. The expected payout number of medals for the Loss is −3.00, respectively. Here, the sum of the expected payout number of medals for these internal winning arrangements is:
12.00−3.00=9.00.
In other words, the expected payout number of medals that the player can obtain in one game in the RB gaming state converges to 9.00 in a long term when three (3) medals are bet.

Like the case with two (2) medals bet, the number of medals to be paid for an internal winning arrangement of the RB is equal to 72 which is a result from the multiplication of an expected payout number of medals of 9.00 in one game in the RB gaming state by eight, which is the number of times that the sub winning arrangement of Bell may be internally won in one RB gaming state, when three (3) medals are bet since one RB gaming state ends with eight internal wins of the sub winning arrangement of Bell.

Here, comparing between FIGS. 5A and 5B, the expected payout number of medals that the player can obtain in one game is zero when two (2) and three (3) medals are bet in the general gaming state. In this case, when the player plays a game with 50 medals, for example, the quotient of the division of 50 by an absolute value of 4.5 of the sum of the expected numbers of obtained medals for the internal winning arrangements excluding the RB is about 11 in the general gaming state when two (2) medals are bet. On the other hand, the quotient of the division of 50 by an absolute value of 1.17 of the sum of the expected payout numbers of medals for the internal winning arrangements excluding the RB is about 42 in the general gaming state when three (3) medals are bet. Therefore, the number of games that the player can continuously play with 50 medals is at least 11 when two (2) medals are bet and is at least 42 when three (3) medals are bet. As a result, it can be said that the case with three (3) medals bet is more advantageous to a player in the general gaming state than the case with two (2) medals bet.

On the other hand, in the high probability re-gaming state (non-carry-over), the expected payout number of medals that the player can obtained in one game is 0.84 when two (2) medals are bet and is 0.03 when three (3) medals are bet. Therefore, it can be said that the case with two (2) medals bet is more advantageous to a player than the case with three (3) medals bet.

In this way, providing different probabilities that the internal winning arrangements can be won in accordance with the gaming state and the number of BETs can sometimes differentiate the degree of advantageousness to the player. Thus, the variety of the game can be enhanced, which may improve the amusement to a player.

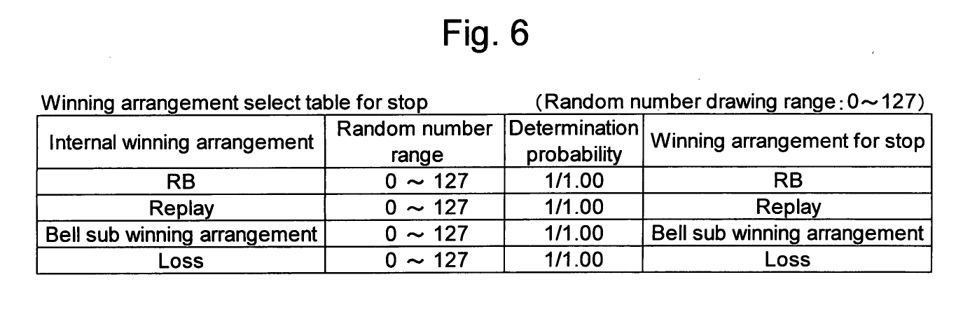

A stop winning arrangement select table will be described with reference to FIG. 6. The table is stored in the ROM 32 in FIG. 10, which will be described later and is referred in the stop winning arrangement determination processing in step S14 in FIG. 11B. The range of random number extraction (or drawing) of the table is 0 to 127. As shown in FIG. 6, all internal winning arrangements are directly applicable to the stop winning arrangements at 100% of probability.

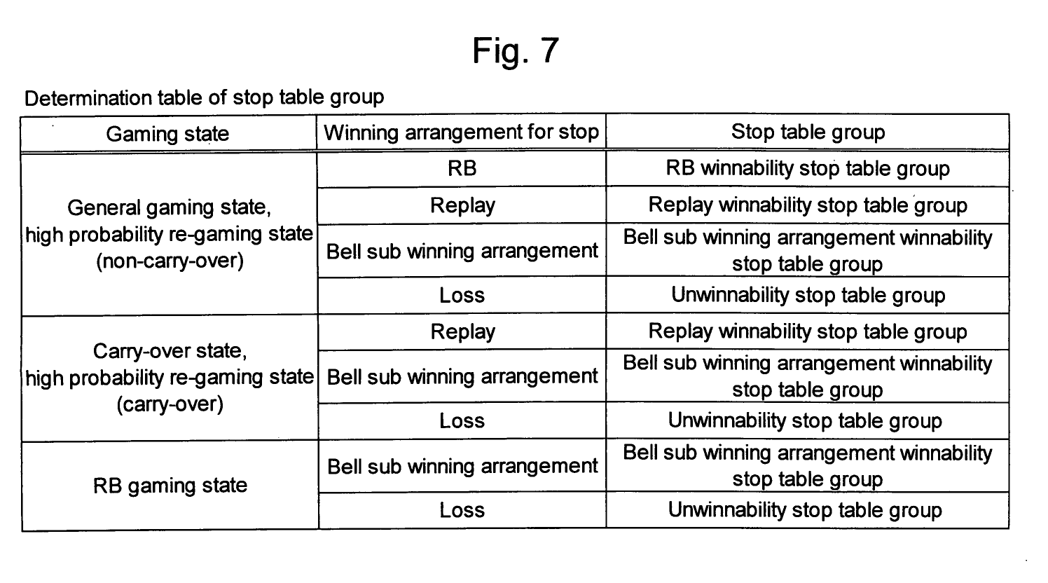

A stop table group determining table will be described with reference to FIG. 7. The table is stored in the ROM 32 in FIG. 10, which will be described later and is referred to in the stop winning arrangement determination processing in step S14 in FIG. 11B. As shown in FIG. 7, each stop table group is selected based on the gaming state and the -stop winning arrangement. The stop table group is a set of stop tables to be used for controlling the stop of varying reels 3L, 3C and 3R such that a specific winning arrangement is or can be completed on an activated line. Here, the RB can be won when the RB winnability stop table group is selected. The Replay is always won when the Replay winnability stop table group is selected. The sub winning arrangement of Bell is always won when the Bell sub winning arrangement winnability stop table group is selected. However, no winning arrangement is won even with any form of stop operation by the player when the unwinnability (or non-winnability) stop table group is selected.

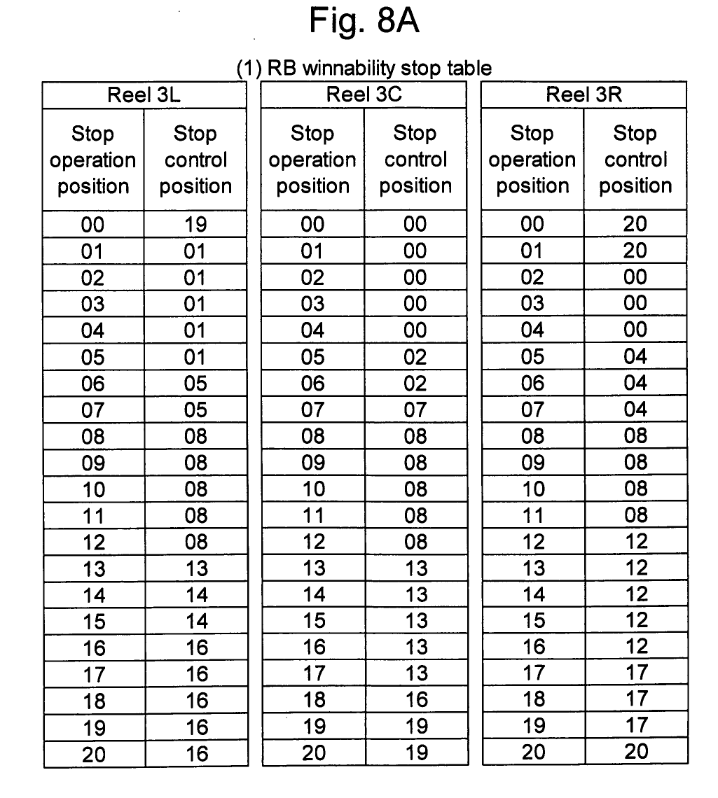

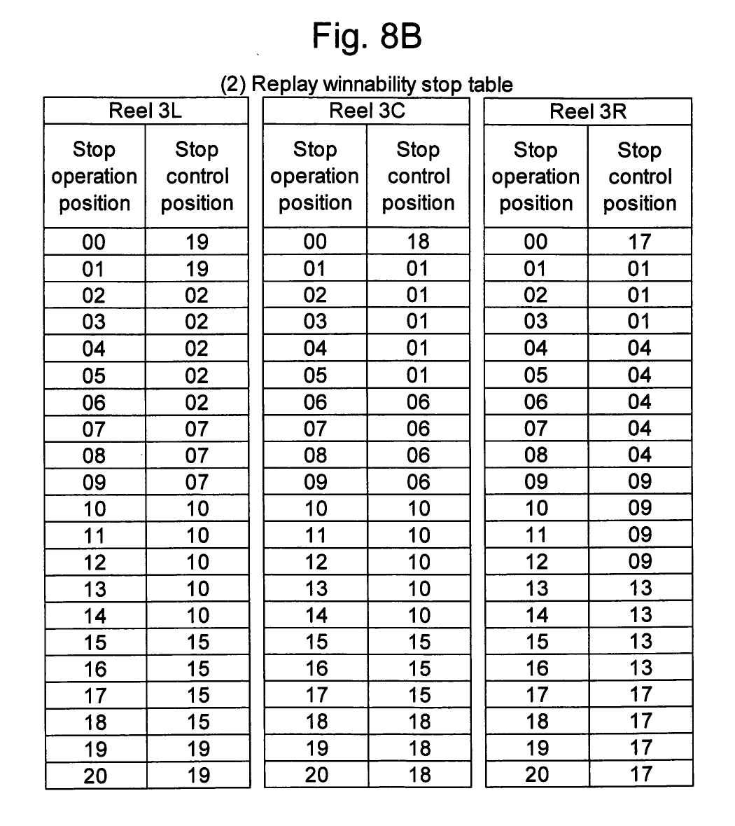

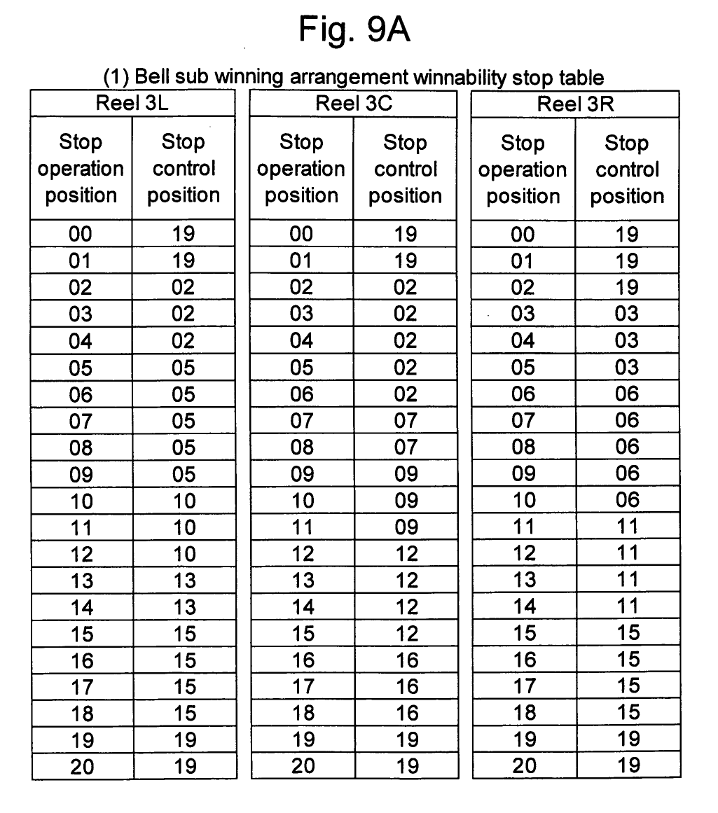

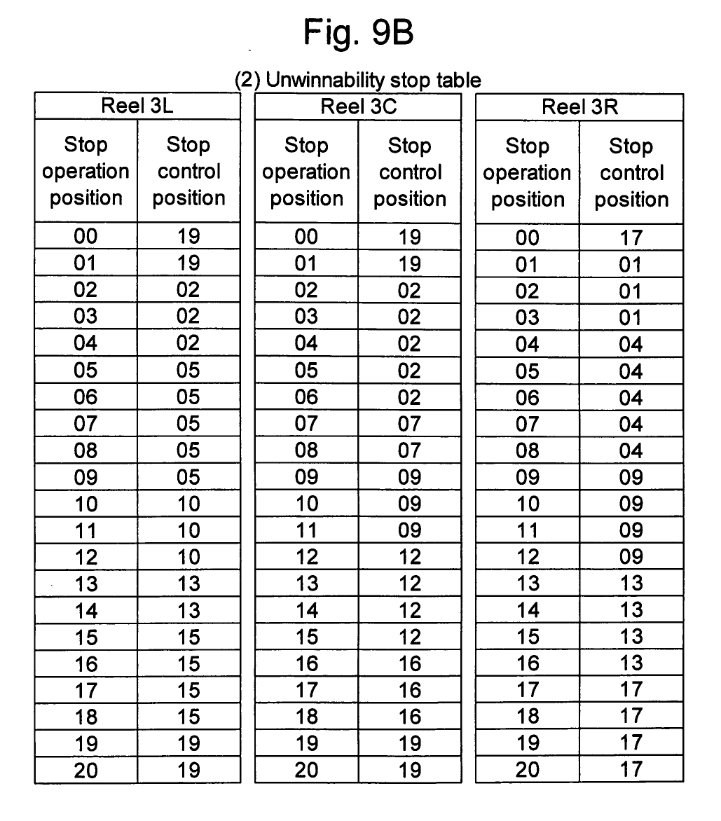

FIGS. 8A and 8B and FIGS. 9A and 9B show stop table examples included in the stop table groups shown in FIG. 7. Each of the stop tables stores information on correspondences between code numbers from 00 to 20 referring to stop operation positions and stop control positions of the reels 3L, 3C and 3R corresponding to the stop operation positions.

Each of the stop tables shows stop operation positions and stop control positions of the reels 3L, 3C and 3R. The stop operation positions indicate code numbers of symbols positioned at the center line 8c (symbols the center of which is positioned above the center line 8c and is the closest to the position of the center line 8c) when the stop buttons 7L, 7C and 7R provided for the reels 3L, 3C and 3R, respectively. The stop control positions indicate code numbers of symbols stopped at the position of the center line 8c when the reels subject to stop operations are stopped.

Here, according to this embodiment, the so-called number of sliding frames is “4 frames” maximum. For example, when “Bell” with the code number 09 reaches the position of the center line 8c during the rotation of the right reel 3R, the right 3R can be controlled to stop such that “Bell” with the code number 07 can be stopped at the position of the center line 8c in response to an operation on the stop button 7R.

FIG. 8A is an RB winnability stop table example included the RB winnability stop table group. The table is used for controlling reels to stop such that the RB can be won.

In FIG. 8A, the stop control position of the reel 3L is one of code numbers 01, 05, 08, 13, 14 and 16. In the symbol column shown in FIG. 2, the symbols one above the symbols corresponding thereto are “Red7”, “Bell”, “BAR”, “Bell”, “Blue7” and “BAR”, respectively.

In FIG. 8A, the stop control position of the reel 3C is one of code numbers 00, 02, 07, 08, 13, 16 and 19. In the symbol column shown in FIG. 2, the symbols one above the symbols corresponding thereto are “Red7”, “Bell”, “Bell”, “Blue7”, “BAR”, “Bell” and “Bell”, respectively.

In FIG. 8A, the stop control position of the reel 3R is one of code numbers 00, 04, 08, 12, 17 and 20. In the symbol column shown in FIG. 2, the symbols one below the symbols corresponding thereto are “Red7”, “Replay”, “Blue7”, “BAR”, “Replay”, and “Red7”, respectively.

As described above, when the RB winnability stop table shown in FIG. 8A is used for the stop control of the reels 3L, 3C and 3R, “Red7-Red7-Red7”, “Blue7-Blue7-Blue7” or “BAR-BAR-BAR” are stopped at the cross-down line 8e, which may achieve a win of RB.

FIG. 8B is an example of the Replay winnability stop table included in the Replay winnability stop table group. The table is used for controlling stopping of the reels such that the Replay can be won.

In FIG. 8B, the stop control position of the reel 3L is one of code numbers 02, 07, 10, 15 and 19. In the symbol column shown in FIG. 2, the symbols one above the symbols corresponding thereto are all “Replay”.

In FIG. 8B, the stop control position of the reel 3C is one of code numbers 01, 06, 10, 15 and 18. In the symbol column shown in FIG. 2, the symbols corresponding thereto are all “Replay”.

In FIG. 8B, the stop control position of the reel 3R is one of code numbers 01, 04, 09, 13 and 17. In the symbol column shown in FIG. 2, the symbols one below the symbols corresponding thereto are all “Replay”.

As described above, when the RB winnability stop table shown in FIG. 8B is used for the stop control of the reels 3L, 3C and 3R, “Replay-Replay-Replay” are stopped at the cross-down line 8e, which may achieve a win of the Replay.

FIG. 9A is an example of the Bell sub winning arrangement winnability stop table included in the Bell sub winning arrangement winnability stop table group. The table is used for controlling stopping of the reels such that the sub winning arrangement of Bell can be won.

In FIG. 9A, the stop control position of the reel 3L is one of code numbers 02, 05, 10, 13, 15 and 19. In the symbol column shown in FIG. 2, the symbols one above the symbols corresponding thereto are all “Bell”.

In FIG. 9A, the stop control position of the reel 3C is one of code numbers 02, 07, 09, 12, 16 and 19. In the symbol column shown in FIG. 2, the symbols corresponding thereto are all “Bell”.

In FIG. 9A, the stop control position of the reel 3R is one of code numbers 03, 06, 11, 15 and 19. In the symbol column shown in FIG. 2, the symbols one below the symbols corresponding thereto are all “Bell”.

As described above, when the Bell sub winning arrangement winnability stop table shown in FIG. 9A is used for the stop control of the reels 3L, 3C and 3R, “Bell-Bell-Bell” are stopped at the cross-down line 8e, which may achieve a win of the sub winning arrangement of Bell.

FIG. 9B is an example of the unwinnability (or non-winnability) stop table included in the unwinnability (or non-winnability) stop table group. The table is used for controlling stopping of the reels such that no winning arrangement can be won.

In FIG. 9B, the stop control position of the reel 3L is one of code numbers 02, 05, 10, 13, 15 and 19. In the symbol column shown in FIG. 2, the symbols one above the symbols corresponding thereto are all “Bell”.

In FIG. 9B, the stop control position of the reel 3C is one of code numbers 02, 07, 09, 12, 16 and 19. In the symbol column shown in FIG. 2, the symbols corresponding thereto are all “Bell”.

In FIG. 9B, the stop control position of the reel 3R is one of code numbers 01, 04, 09, 13 and 17. In the symbol column shown in FIG. 2, the symbols one below the symbols corresponding thereto are all “Replay”.

As described above, when the unwinnability (or non-winnability) stop table shown in FIG. 9B is used for the stop control of the reels 3L, 3C and 3R, “Bell-Bell-Replay” are stopped at the cross-down line 8e, which may achieve no win.

FIG. 10 shows a circuit construction including a main control circuit 71, peripheral devices (actuators), and a sub control circuit 72. The main control circuit 71 controls a gaming processing operation in the gaming machine 1 according to this embodiment. The peripheral devices electrically connect to the main control circuit 71. The sub control circuit 72 controls the LCD device 5, speakers 21L and 21R, LEDs 101 and lamps 102 based on a control command transmitted from the main control circuit 71.

The main control circuit 71 mainly includes a microcomputer 30 provided on a circuit substrate and further includes a circuit for random sampling. The microcomputer 30 includes a CPU 31, the ROM 32 and a RAM 33. The CPU 31 performs a control operation in accordance with a predetermined program. The ROM 32 and RAM 33 are storage units.

The CPU 31 is connected to a clock pulse generation circuit 34 for generating a reference clock pulse, a frequency divider 35, a random number generator 36 for generating a random number to be sampled and a sampling circuit 37. Notably, as a unit for random number sampling, random number sampling may be configured to implement within the microcomputer 30, that is, on an operating program of the CPU 31. In this case, the random number generator 36 and sampling circuit 37 may be omitted or may be left as backup for a random number sampling operation.

The ROM 32 of the microcomputer 30 stores the probability lottery tables (FIGS. 5A and 5B) for use in the determination of random number sampling to be performed for each operation (start operation) on the start lever 6, stop tables (FIGS. 8A and 8B) for determining a stop form of a reel in accordance with an operation on one of the stop buttons, control commands to be transmitted to the sub control circuit 72 and tables. Communication is performed in one direction from the main control circuit 71 to the sub control circuit 72 where the sub control circuit 72 does not have to input any command and information to the main control circuit 71. The RAM 33 stores various information. For example, the RAM 33 stores information on a gaming state.

Among the circuits in FIG. 10, the main actuators the operations of which are controlled by control signals from the microcomputers 30 may include BET lamps (including the single bet lamp 9a, double bet lamp 9b and maximum BET lamp 9c), the information display unit 18, a hopper (including a driving portion for payout) 40 for paying out a predetermined number of medals in accordance with a command from a hopper drive circuit 41 and stepping motors 49L, 49C and 49R for rotationally driving the reels 3L, 3C and 3R.

Furthermore, a motor drive circuit 39 for driving and controlling the stepping motors 49L, 49C and 49R, the drive circuit 41 for driving and controlling the hopper 40, a lamp drive circuit 45 for driving and controlling the BET lamps 9a, 9b and 9c, and a display drive circuit 48 for driving and controlling the information display unit 18 are connected to the output of the CPU 31. These drive circuits control operations of the actuators in response to control signals such as drive commands output from the CPU 31.

Main input signal generating units for generating an input signal required for generating a control command by the microcomputer 30 may include a start switch 6S, a single bet switch 11, a double bet switch 12, a maximum BET switch 13, a C/P switch 14, a medal sensor 22S, a reel stop signal circuit 46, a reel position detection circuit 50 and a payout completion signal circuit 51.

The start switch 6S detects an operation on the start lever 6. The medal sensor 22S detects a medal inserted through the medal insertion slot 22. The reel stop signal circuit 46 generates a stop signal in accordance with an operation on each of the stop buttons 7L, 7C and 7R. The reel position detection circuit 50 supplies the CPU 31 a signal for detecting a position of each of the reels 3L, 3C and 3R in response to a pulse signal from a reel rotation sensor. The payout completion signal circuit 51 generates a signal for detecting completion of medal payout when the count value of a medal detection unit 40S (that is, the number of medals paid from the hopper 40) reaches a predetermined number-of-medals data.

Among the circuits in FIG. 10, the random generator 36 generates a random number belonging to a predetermined range of values. The sampling circuit 37 samples one random number in a timing after the start lever 6 is operated. A winning arrangement is determined based on the sampled random number and a probability lottery table stored in the ROM 32.

After the rotations of the reels 3L, 3C and 3R are started, the number of drive pulses supplied to the stepping motors 49L, 49C and 49R is counted, and the count value is written in a predetermined area of the RAM 33. Reset pulses are obtained from the reels 3L, 3C and 3R for each rotation, and the pulses are input to the CPU 31 through the reel position detection circuit 50. The obtained reset pulses clear the count value of the drive pulses, which are counted in the RAM 33, to zero (0). Thus, a count value corresponding to a rotational position within a range of one rotation for each of the reels 3L, 3C and 3R is stored in the RAM 33.

A symbol table (not shown) is stored in the ROM 32 for mapping the rotational positions of the reels 3L, 3C and 3R and symbols rendered on the reel peripheries. The symbol table has a correspondence between a code number sequentially given to each predetermined rotation pitch of each of the reels 3L, 3C and 3R and a symbol code referring to a symbol given for each of the code numbers with respect to the rotational position where the reset pulses are generated.

A winning symbol combination table (not shown) is further stored in the ROM 32. The winning symbol combination table has a correspondence among a winnability symbol combination, a number of won payout medals and a win determination code referring to the win. The winning symbol combination table is referred to for stop control of the left reel 3L, center reel 3C and right reels 3R and for checking a win after the stops of all of the reels 3L, 3C and 3R.

When a win is determined through extraction (or drawing) processing (processing extraction processing) based on the random number sampling, the CPU 31 transmits a signal for controlling to stop the reels 3L, 3C and 3R to a motor drive circuit 39 based on an operation signal transmitted from the reel stop signal circuit 46 when a player operates the stop buttons 7L, 7C and 7R and a selected stop table.

When a stop form (winning arrangement) exhibits a win of a winning arrangement, the CPU 31 supplies a payout command signal to the hopper drive circuit 41 and pays a predetermined number of medals from the hopper 40. In this case, the medal detection unit 40S counts the number of medals paid from the hopper 40 and inputs a medal payout completion signal to the CPU 31 when the count value reaches a predetermined number. Thus, the CPU 31 stops the driving of the hopper 40 through the hopper drive circuit 41 and ends the medal payout processing.

A control operation of the CPU 31 of the main control circuit 71 will be described with reference to the main flowchart shown in FIGS. 11 to 13.

First of all, the CPU 31 performs the initialization for starting a game (step S1). More specifically, the CPU 31 may initialize data stored in the RAM 33 and communication data, for example. Subsequently, the CPU 31 deletes predetermined stored data in the RAM 33, which is stored at the end of the last game (step S2). More specifically, the CPU 31 may delete data in a writable area of the RAM 33, which is used in the last game, write a parameter required for the next game in a writable area of the RAM 33 and selects a start address of a sequence program of the next game, for example. Next, whether “30 seconds” have passed after the end of the last game, that is, after the stops of all of the reels 3L, 3C and 3R or not is determined (step S3). If the determination results in “YES”, the CPU 31 transmits a demo-display command that requests the display of a demo image for informing a player of a standby state to the sub control circuit 72 (step S4). If the determination results in “NO”, the CPU moves the processing to step S5.

In step S5, the CPU 31 determines whether automatic insertion of a medal is requested or not, that is, whether Replay was won in the last game or not. If the determination results in “YES”, the number of medals requested to be inserted are automatically inserted (step S6) and moves the processing to step S8. If the determination in step S5 results in “NO”, the CPU 31 determines whether any input is given from the medal sensor 22S or the BET switch 11, 12 or 13 or not (step S7). If the determination results in “YES”, the processing moves to step S8. If the determination results in “NO”, the processing moves to step S3. In step S8, the CPU 31 transmits a medal insertion command including information on the fact that a medal has been inserted (bet) to the sub control circuit 72 and moves the processing to step S9.

In step S9, the CPU 31 determines whether any input is given from the start switch 6S based on an operation on the start lever 6 or not. If the determination results in “YES”, the CPU 31 extracts a random number for a lottery to be used in step S12, which will be described later, (step S10) and moves the processing to step S11. If the determination in step S9 results in “NO”, the CPU 31 repeats step S9. In step S11, the CPU 31 performs gaming state monitoring processing and moves the processing to step S12. In the gaming state monitoring processing, the CPU 31 determines whether the gaming state shift requirement is satisfied or not. If the CPU 31 determines that the gaming state shift requirement is satisfied, the gaming state is shifted. The current gaming state is maintained if the CPU 31 does not determine that the gaming state shift requirement is satisfied. For example, when the RB is unexpectedly lost in the last game even though the RB has been internally won, the gaming state is shifted from the general gaming state to the carry-over state or from the high probability re-gaming state (non-carry-over) to the high probability re-gaming state (carry-over) until a predetermined requirement is satisfied after the current game based on the information that RB has been internally won.

In step S12, the CPU 31 performs probability lottery processing and moves the processing to step S15. In the probability lottery processing, the CPU 31 determines one internal winning arrangement based on the extracted random number value extracted in step S10 with reference to the probability lottery table (stored in the ROM 32 (see FIG. 10)) in accordance with the number of BETs and the current gaming state. For example, when the gaming state is the general gaming state, the CPU 31 determines an internal winning arrangement with reference to the probability lottery table (FIG. 4A or 4B) for the general gaming state (with 2 or 3 medals bet) in accordance with the number of BETs. When the gaming state is the carry-over state, the CPU 31 determines an internal winning arrangement with reference to the probability lottery table (not shown) for the carry-over state (with 2 or 3 medals bet) in accordance with the number of BETs. When the gaming state is the high probability re-gaming state (non-carry-over), the CPU 31 determines an internal winning arrangement with reference to the probability lottery table (FIG. 4C or 4D) for the high probability re-gaming state (non-carry-over) (with 2 or 3 medals bet) in accordance with the number of BETs. When the gaming state is the high probability re-gaming state (carry-over), the CPU 31 determines an internal winning arrangement with reference to the probability lottery table (not shown) for the high probability re-gaming state (carry-over) (with 2 or 3 medals bet) in accordance with the number of BETs.

In step S15, the CPU 31 performs command creating processing upon start of a game and moves the processing to step S16. In step S16, the CPU 31 transmits a start command including a gaming state, an internal winning arrangement and a stop winning arrangement to the sub control circuit 72 and moves the processing to step S17.

In step S17, the CPU 31 determines whether “4.1 seconds” has passed or not from the start of the last game. If the determination results in “YES”, the processing moves to step S19. If the determination results in “NO”, the processing moves to step S18. In step S18, game-start standby-time consuming processing is performed, and the processing moves to step S19. More specifically, up to the passage of “4.1 seconds” since the start of the last game, processing is performed for invalidating an input based on an operation for starting a game by a player.

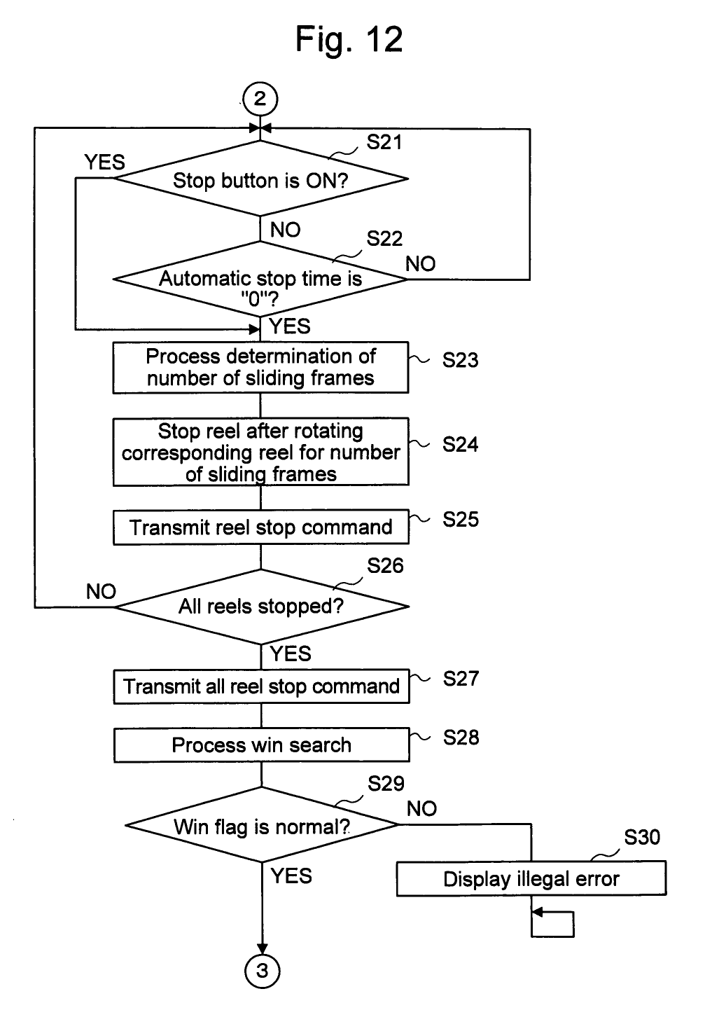

In step S19, the CPU 31 performs reel rotation processing and moves the processing to step S20. In step S20, when the speed of rotations of the reels 3L, 3C and 3R reaches a predetermined speed of rotation, the CPU 31 transmits a reel stop permit command to the sub control circuit 72 and moves the processing to step S21 in FIG. 12. The reel stop permit command is information indicating that the operations on the stop buttons 7L, 7C and 7R by a player are validated.

In step S21, the CPU 31 determines whether any one of stop buttons is “ON” or not. More specifically, the CPU 31 determines whether any one of the stop buttons 7L, 7C and 7R is operated or not. If the determination results in “YES”, the processing moves to step S23 while, if the determination results in “NO”, the processing moves to step S22. In step S22, the CPU 31 determines whether the value of the automatic stop timer is zero (0) or not. If the determination results in “YES”, the processing moves to step S23 while, if “NO”, the processing moves to step S21.

In step S23, the CPU 31 performs number-of-slide-frames determination processing for determining a number of sliding frames. More specifically, the CPU 31 selects a stop table corresponding to a determined (selected) stop winning arrangement and determines the numbed of sliding frames based on the selected stop table. In other words, the CPU 31 determines the number of sliding frames in accordance with the stop winning arrangement determined based on whether winning of an internal winning arrangement and a carry-over winning arrangement is permitted or not (such as the determination result by the win permission determining unit). Subsequently, the CPU 31 rotates and then stops a reel corresponding to the stop button subject to a stop operation (step S24) and transmits to the sub control circuit 72 a reel stop command including information on a reel to be stop-controlled (step S25).

Next, the CPU 31 determines whether all of the reels 3L, 3C and 3R have stopped or not (step S26). If the determination results in “YES”, the processing moves to step S27 while, if “NO”, the processing moves to step S21. In step S27, the CPU 31 transmits an all-reels stop command indicating that all of the reels 3L, 3C and 3R have stopped, and the processing moves to step S28. Here, the sub control circuit 72 having received the all-reels stop command controls back lamps at the back of the reels 3L, 3C and 3R and the speakers 21L and 21R.

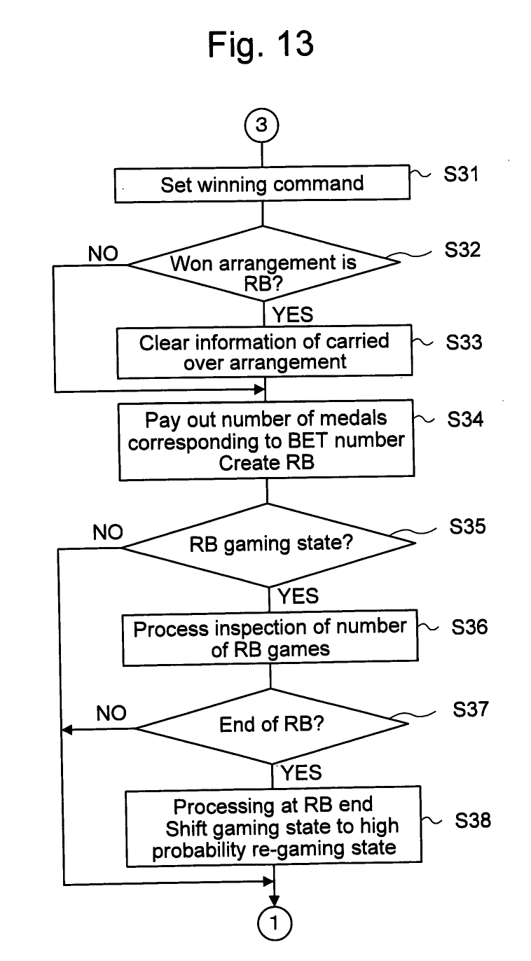

In step S28, the CPU 31 performs a win search. The win search refers to setting a win flag for identifying a won arrangement (that is, an arrangement that has been won) based on a form of stopped symbols in the display windows 4L, 4C and 4R. More specifically, a won arrangement is identified based on code numbers of symbols completed on the center line 8c and the win determination table. Then, the CPU 31 determines whether a win flag is normal or not (step S29). If the determination results in YES”, the processing moves to step S31 in FIG. 13. If “NO”, the CPU 31 displays an illegal error (step S30). In this case, the current game is stopped.

In step S31 in FIG. 13, the CPU 31 sets (transmits) a winning command including information on a won arrangement, the processing moves to step S32. In step S32, the CPU 31 determines whether the won arrangement is RB or not. If the determination results in “YES”, the processing moves to step S33 while, if “NO”, the processing moves to step S34.

In step S33, the CPU 31 clears (deletes) the information on the carried over arrangement (RB) and moves the processing to step S34. In step S34, the CPU 31 credits or pays out a medal in accordance with the gaming state and shifts the gaming state to the RB gaming state in accordance with the won arrangement. Then, the processing moves to step S35.

In step S35, the CPU 31 determines whether the gaming state is the RB gaming state or not. If the determination results in “YES”, the processing moves to step S36 while, if “NO”, the processing moves to step S2 in FIG. 11A. In step S36, the CPU 31 performs RB number-of-games check processing and moves to step S37. In step S37, the CPU 31 determines whether the RB gaming state ends or not. If the determination results in “YES”, the processing moves to step S38 while, if “NO”, the processing moves to step S2 in FIG. 11A. In step S38, the CPU 31 performs RB ending processing for shifting the gaming state to the high probability re-gaming state, for example, and the processing moves to step S2 in FIG. 11A.

Here, in the RB gaming state, the determination in step S37 results in “YES” when the number of wins of the sub winning arrangement of Bell is eight or when the number of games is twelve.

According to this embodiment, the gaming machine 1 has the most simplified gaming characteristics for plain description of characteristics of the invention. For example, though four kinds of winning arrangements including RB, Replay, sub winning arrangement of Bell and the Loss are defined in the gaming machine 1 in this embodiment, the present invention is not limited thereto. More winning arrangements can be defined. Furthermore, though the first special won game (RB) is only defined in the gaming machine 1 in this embodiment, a won game serially operating device (Big Bonus or BB) may be provided which operates the first special won game continuously. The BB (BB gaming state) serving as the won game serially operating device ends with payout of a predetermined number of medals (such as 361 medals).

Alternatively, a second kind special won game (Challenge Game or CG and/or Single Challenge Game or SCG) and a won game serially operating device (Challenge Time or CT) which serially operates the second kind special won game may be provided. Furthermore, a general won game (such as Single Bonus or SB) may be provided.

The gaming machine 1 of this embodiment includes a stop control unit (such as the main control circuit 71 for implementing step S24 in FIG. 12). When CT is defined, the gaming machine 1 has a number-of-slide-displays determining unit that determines a number of slide displays (such as number of sliding frames) within numbers equal to or lower than a predetermined maximum number of slide displays (such as four frames) from the time when the stop control unit performs predetermined initial stop control to the time when varying of the reels 3L, 3C and 3R is stopped. The number of slide displays is a number of identification information pieces (such as kinds of symbols shown in FIG. 2) to be displayed on variable display units including the reels 3L, 3C and 3R. Then, under a condition that the gaming state is a specific gaming state (such as the CT gaming state), the number-of-slide-displays determining unit is configured o determine the number of slide displays (such as 0, 1 and 2) within numbers equal to or lower than a specific maximum number of slide displays. Thus, the gaming characteristic of CT can be implemented.

Describing CT in other words, the gaming machine 1 includes a CT gaming state, and, in the CT gaming state, one (1) is defined as the maximum number of sliding frames (maximum number of slide displays) for one or more reels basically. On the other hand, 4 is defined as the maximum number of sliding frames in the gaming states excluding the CT gaming state. The number of sliding frames is basically a number of symbols to be moved on the display in a period from the time when the stop buttons 7L, 7C and 7R are operated (an input of an operation signal is detected) to the time when the reels 3L, 3C and 3R are stopped. Furthermore, the number of sliding frames is a number of symbols (strokes of symbols) moved in the period from the time when the stop buttons 7L, 7C and 7R are operated to the time when the respective reels 3L, 3C and 3R are stopped. More specifically, the number of sliding frames is equal to the number of symbols having crossed a predetermined winning line such as the center line 8c in the period from the time when the stop buttons 7L, 7C and 7R are operated to the time when the respective reels 3L, 3C and 3R are stopped. In this way, when the gaming state of the gaming machine 1 is the CT gaming state, the number of sliding frames is lower than those of the other gaming states, and pull-in control is relatively not performed. Therefore, the degree of freedom is increased for the technical intervention including observation push by a player, which may increase the game amusement.

As described above, even when more kinds of winning arrangements are defined in the gaming machine 1, the present invention can be implemented by managing, in accordance with the number of BETs, the winning probabilities of internal winning arrangements managed by winning probability managing means and payout number managing means and the number of medals to be paid out to a player in accordance with one of the internal winning arrangements. In other words, probability lottery tables are prepared which are different for each number of BETs, and the probability lottery table has different probabilities on which internal winning arrangements can win for each gaming state. For example, in the general gaming state, when the absolute value of the sum of the expected number of medals obtained for internal winning arrangements excluding bonuses (such as BB, RB and CT) when 2 medals are bet and the absolute value of the sum of the expected number of medals obtained for internal winning arrangements excluding bonuses when 3 medals are bet are compared, the number of medals to be paid out to a player is managed in accordance with the winning probability of an internal winning arrangement and the internal winning arrangement such that the value of the former case can be lower than the value of the latter case. In the high probability re-gaming state, when the sum of the expected number of medals obtained when 2 medals are bet and the sum of the expected number of medals obtained when 3 medals are bet are compared, the number of medals to be paid out to a player is managed in accordance with the winning probability of an internal winning arrangement and the internal winning arrangement such that the value of the former case can be higher than the value of the latter case. In this case, in the gaming machine 1, the winning probability managing means manages the winning probability of an internal winning arrangement in accordance with the number of BETs, and the payout number managing means manages the number of medals to be paid to a player in accordance with the internal winning arrangement. Thus, for example, a case with 3 medals bet is more advantageous to a player than a case with 2 medals bet in the general gaming state while a case with 2 medals bet is more advantageous to a player than a case with 3 medals bet in the high probability re-gaming state. Therefore, various gaming characteristics can be provided to the gaming machine 1, which may improve the game amusement.

In the description of this embodiment, the probability lottery tables for the general gaming state and high probability re-gaming state with 2 and 3 medals bet are used, and a case using the one with 1 medal bet is not described. However, the winning probability managing means and payout number managing means may be freely designed or changed such that the winning probability of an internal winning arrangement with 1 medal bet and a number of medals to be paid to a player in accordance with and the internal winning arrangement can be managed. Thus, for example, a case with 2 medals bet can be more advantageous to a player in the general gaming state while the number of BETs of 1 can be more advantageous to a player in the high probability re-gaming state.

Requirements for shifting the gaming state to the high probability re-gaming state includes (a) to (e) below.
(a): A requirement device relating to an operation of a first kind special won game (RB or CG and/or SCG) or a winning arrangement serially operating device (BB or CT) operates (that is, the bonus flag is ON).
(b): A combination of symbols (“BAR-BAR-BAR” or “Red7-Red7-Red7 or Blue7-Blue7-Blue7) resulting in the operation of a first kind special won game or the won game serially operating device is displayed.
(c): The operation of a first kind special won game or won game serially operating device ends.
(d): A combination of specific symbols is displayed when a requirement device relating to the operation of a first kind special won game or won game serially operating device and the first kind special won game or won game serially operating device does not operate.
(e): Results of a predetermined number of games are obtained after (c) or (d).

Though the special gaming state is the high probability re-gaming state according to this embodiment, the invention is not limited thereto. The special gaming state is the BB gaming state, RB gaming state or CT gaming state, for example.

The present invention is applicable to gaming machines such as a Pachinko gaming machine and a Pachi-slot machine in addition to the gaming machine 1 of this embodiment. Furthermore, the present invention is applicable to a game program that artificially executing operations of the gaming machine 1 as a home gaming machine, whereby a game can be implemented. In this case, a storage medium storing the game program may be a CD-ROM, an FD (flexible disk) or any other storage medium.

What is claimed is:

1. A gaming machine, which performs a unit game upon insertion of game values by a player, comprising:
winning probability managing means for managing a winning probability for each winning arrangement based on an amount of the game values inserted by the player;
winning arrangement determining means for determining the winning arrangement based on said winning probability managed by said winning probability managing means and a random number extracted by a lottery for a unit game;
payout number managing means for managing an amount of gaming values paid out to said player in association with said winning arrangement having been determined by said winning arrangement determining means and the amount of the gaming values inserted by said player; and
gaming state shift means for shifting a gaming state between a general gaming state in which a predetermined arrangement is determined as the winning arrangement based on a first winning probability being managed by said winning probability managing means and a special gaming state in which said predetermined arrangement is determined as the winning arrangement based on a second winning probability being higher than said first winning probability and being managed by said winning probability managing means.

2. The gaming machine according to claim 1, wherein the winning probability managing means comprises at least one probability lottery table.

3. The gaming machine according to claim 1, wherein the winning arrangement determining means comprises a main control circuit which performs probability lottery processing.

4. The gaming machine according to claim 1, wherein the gaming values comprise medals, coins, tokens, credit numbers, or combination thereof.

5. A gaming machine comprising:
a CPU, which controls a game to be performed in the gaming machine;
a display device, which performs varying displays of a plurality of kinds of symbols in at least two areas within the display device such that the plurality of kinds of symbols appear in the at least two areas;
a stop device, which is operated and causes a halt of the varying displays so as to cause each symbol to appear in a stationary manner in each of the at least two areas such that a combination of stationary symbols causes a winning condition if the combination matches a predetermined winning arrangement;
wherein a winning probability for the winning condition depends on a number of medals bet by a player;
wherein the predetermined winning arrangement is determined based on said winning probability managed by at least one probability table and a random number extracted by a lottery for a unit game;
wherein a number of medals to be paid out to said player is determined in association with said winning arrangement and the number of medals bet by said player; and
wherein a gaming state is shifted between a general gaming state in which a predetermined arrangement is determined as the winning arrangement based on a first winning probability and a special gaming state in which said predetermined arrangement is determined as the winning arrangement based on a second winning probability being higher than said first winning probability.
